(19) United States
(12) Patent Application Publication
(10) Pub. No.: US 2008/0100751 A1
(43) Pub. Date: May 1, 2008

(54) RECEPTION MODULE, RECEPTION APPARATUS AND TELEVISION RECEIVER

(76) Inventor: Yoshiaki NAKANO, Osaka (JP)

Correspondence Address: BIRCH STEWART KOLASCH & BIRCH, PO BOX 747, FALLS CHURCH, VA, 22040-0747, US

(21) Appl. No.: 11/857,254

(22) Filed: Sep. 18, 2007

(30) Foreign Application Priority Data
Oct. 30, 2006 (JP) 2006-293793

(51) Int. Cl. H04N 5/50

(52) U.S. Cl. 348/726

(57) ABSTRACT

A reception apparatus (3) which can realize a compact size thereof includes: a tuner circuit portion (5); a digital demodulating portion (6) that converts a signal from the tuner circuit portion into a digital signal; and a digital circuit portion (7) that converts a digital signal from the digital demodulating portion into a digital video signal and digital audio signal, and the reception apparatus is characterized by that a first sub circuit board (30) on which the digital demodulating portion is mounted and a second sub circuit board (40) on which the tuner circuit portion is mounted are stacked on a main circuit board (20) on which the digital circuit portion is mounted, in this order, via solder balls (50, 60), so that the main circuit board, the first sub circuit board, and the second sub circuit board are connected to each other via the solder balls.

This application is based on Japanese Patent Application No. 2006-293793 filed on Oct. 30, 2006, and the contents of which are hereby incorporated by reference.

### BACKGROUND OF THE INVENTION

1. Field of the Invention

The present invention relates to a reception module, a reception apparatus and a television receiver equipped with the reception apparatus, which receive and demodulate a radio frequency signal such as a digital television broadcasting signal.

2. Description of Related Art

A general structure of a conventional television receiver is shown in FIG. 10 as a block diagram. As shown in FIG. 10, a television receiver 101 includes an antenna 102 that receives a radio frequency signal, a reception apparatus 103 that performs a predetermined process on the radio frequency signal from the antenna 102 so as to generate a video signal and an audio signal, a picture and sound output device 104 that delivers pictures and sounds based on the video signal and the audio signal from the reception apparatus 103.

The reception apparatus 103 is equipped with a tuner circuit portion 105 that converts the radio frequency signal received by the antenna 102 into an intermediate frequency signal, a digital demodulating portion 106 that converts the intermediate frequency signal delivered from the tuner circuit portion 105 into a compressed digital signal, a digital circuit portion 107 that converts the compressed digital signal delivered from the digital demodulating portion 106 into a digital video signal and digital audio signal, and a video and audio output circuit 108 that converts the digital video signal and digital audio signal delivered from the digital circuit portion 107 into an analog video signal and analog audio signal. The picture and sound output device 104 is equipped with a display processing portion 114 that performs a process of displaying pictures based on the analog video signal delivered from the video and audio output circuit 108 of the reception apparatus 103, and a sound processing portion 115 that performs a process of producing sounds based on the analog audio signal delivered from the video and audio output circuit 108.

Furthermore, the conventional reception apparatus 103 has a main circuit board 120 that is a mother board on which the digital circuit portion 107 and the video and audio output circuit 108 are mounted, and another child board, i.e., a sub circuit board 130 on which the tuner circuit portion 105 and the digital demodulating portion 106 are mounted with a predetermined space between them as shown in FIG. 11 (see JP-A-2000-68673, for example). The sub circuit board 130 stands on the main circuit board 120 and is connected to the same via a connector.

Conventionally, such a reception apparatus is mainly used in a large television receiver that is used in an ordinary house or the like. Recently, however, some small mobile equipment such as a mobile phone, a mobile information terminal (or a PDA) and the like has the function of television receiver, so the reception apparatus is also used in the mobile equipment.

Since the tuner circuit portion 105 and the digital demodulating portion 106 are disposed on the sub circuit board 130 with a predetermined space between them in the conventional reception apparatus 103, the sub circuit board 130 is required to have a large area to some extent. In addition, the connection structure between the main circuit board 120 and the sub circuit board 130 is also a factor that the entirety of the circuit boards becomes larger. As a result, downsizing of the reception apparatus 103 is restricted, and it is not suitable for a compact size that is required to mobile equipment.

### SUMMARY OF THE INVENTION

The present invention is made in view of the above described problem, ant it is an object of the present invention to provide a reception module and a reception apparatus that can realize a compact size thereof. Further, it is another object of the present invention to provide a television receiver that can realize a compact size thereof.

To attain one of the above described object a reception module in accordance one aspect of the present invention includes: a tuner circuit portion; and a digital demodulating portion that converts a signal from the tuner circuit portion into a digital signal, and the reception module is characterized by a structure in that a first sub circuit board on which the digital demodulating portion is mounted and a second sub circuit board on which the tuner circuit portion is mounted are stacked via conductive bonding members, so that the first sub circuit board and the second sub circuit board are connected to each other via the conductive bonding members.

According to this reception module, the digital demodulating portion and the tuner circuit portion are disposed separately on the first sub circuit board and the second sub circuit board, respectively. Therefore, each area of the first sub circuit board and the second sub circuit board can be reduced.

To attain another one of the above described object a reception apparatus in accordance another aspect of the present invention includes: a tuner circuit portion; a digital demodulating portion that converts a signal from the tuner circuit portion into a digital signal; and a digital circuit portion that converts a digital signal from the digital demodulating portion into a digital video signal and digital audio signal, and the reception apparatus is characterized by a structure in that a first sub circuit board on which the digital demodulating portion is mounted and a second sub circuit board on which the tuner circuit portion is mounted are stacked on a main circuit board on which the digital circuit portion is mounted, in this order, via conductive bonding members, so that the main circuit board, the first sub circuit board, and the second sub circuit board are connected to each other via the conductive bonding members.

According to this reception apparatus, since the digital demodulating portion and the tuner circuit portion are disposed separately on the first sub circuit board and the second sub circuit board, respectively, each area of the first sub circuit board and the second sub circuit board can be reduced. Further, the first sub circuit board is stacked on the main circuit board via conductive bonding members, and the second sub circuit board is stacked on the first sub circuit board via conductive bonding members, so that electric connection is realized among them. Therefore, the entirety of the circuit boards can be controlled to be thin. Thus, the reception apparatus can be downsized.

To attain other one of the above described object a television receiver in accordance other aspect of the present invention includes: the reception apparatus as above described which is provided with a video and audio output circuit that converts the digital video signal and digital audio signal from the digital circuit portion into an analog video signal and analog audio signal; and a picture and sound output device that displays pictures based on a video signal delivered from the reception apparatus and produces sounds based on an audio signal delivered from the reception apparatus.

According to this television receiver, in the reception apparatus thereof, since the digital demodulating portion and the tuner circuit portion are disposed separately on the first sub circuit board and the second sub circuit board, respectively, each area of the first sub circuit board and the second sub circuit board can be reduced. Further, the first sub circuit board is stacked on the main circuit board via conductive bonding members, and the second sub circuit board is stacked on the first sub circuit board via conductive bonding members, so that electric connection is realized among them. Therefore, the entirety of the circuit boards can be controlled to be thin. Thus, the reception apparatus can be downsized. As a result, the television receiver equipped with the reception apparatus can also be downsized naturally.

According to the reception apparatus of the present invention, a compact size thereof can be realized. In addition, according to the television receiver of the present invention, a compact size thereof can be realized.

### BRIEF DESCRIPTION OF THE DRAWINGS

FIG. 1 is a block diagram to show a general structure of a television receiver that is equipped with a reception apparatus according to a first embodiment of the present invention.

FIG. 2 is a cross sectional view to show a schematic structure of circuit boards in the reception apparatus of the first embodiment.

FIG. 3 is a perspective view to show a schematic structure of connection between the circuit boards in the reception apparatus of the first embodiment.

FIG. 4 is a cross sectional view to show a schematic structure of circuit boards in a reception apparatus according to a second embodiment of the present invention.

FIG. 5 is a cross sectional view to show a schematic structure of the circuit boards in the reception apparatus of the second embodiment.

FIG. 6 is a plan view to show schematically first and second ground layers in circuit boards in a reception apparatus according to a third embodiment of the present invention.

FIG. 7 is a cross sectional view to show a schematic structure of circuit boards in a reception apparatus according to a fourth embodiment of the present invention.

FIG. 8 is a perspective view to show a schematic structure of circuit boards in a reception apparatus according to a fifth embodiment of the present invention.

FIG. 9 is a cross sectional view to show schematically a variation of the structure of the circuit board in the reception apparatus of the present invention.

FIG. 10 is a block diagram to show a general structure of a conventional television receiver.

FIG. 11 is a perspective view to show a schematic structure of a sub circuit board among circuit boards in a conventional reception apparatus.

### DETAILED DESCRIPTION OF THE PREFERRED EMBODIMENTS

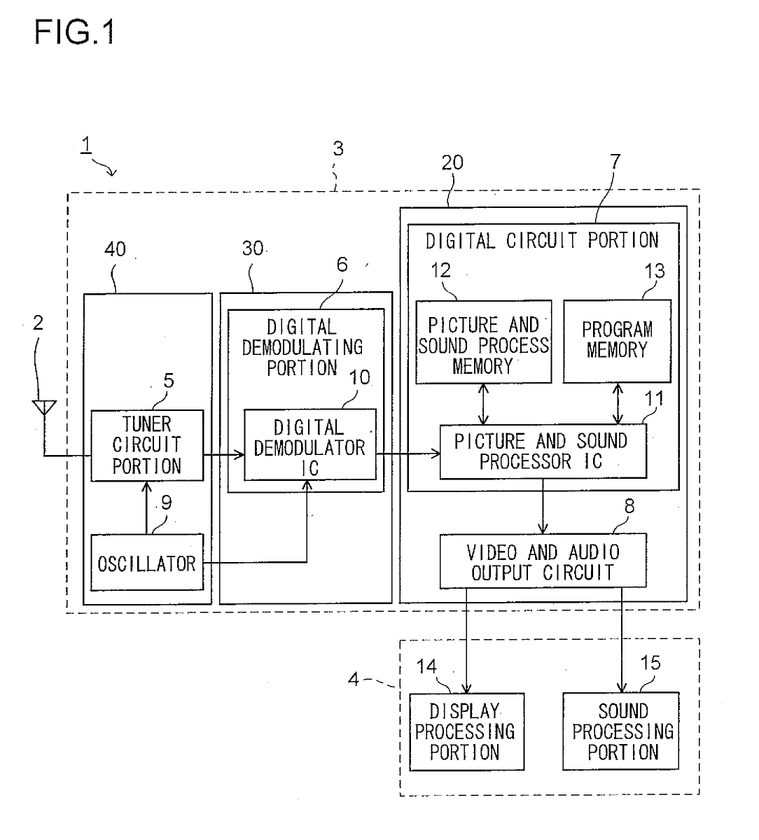

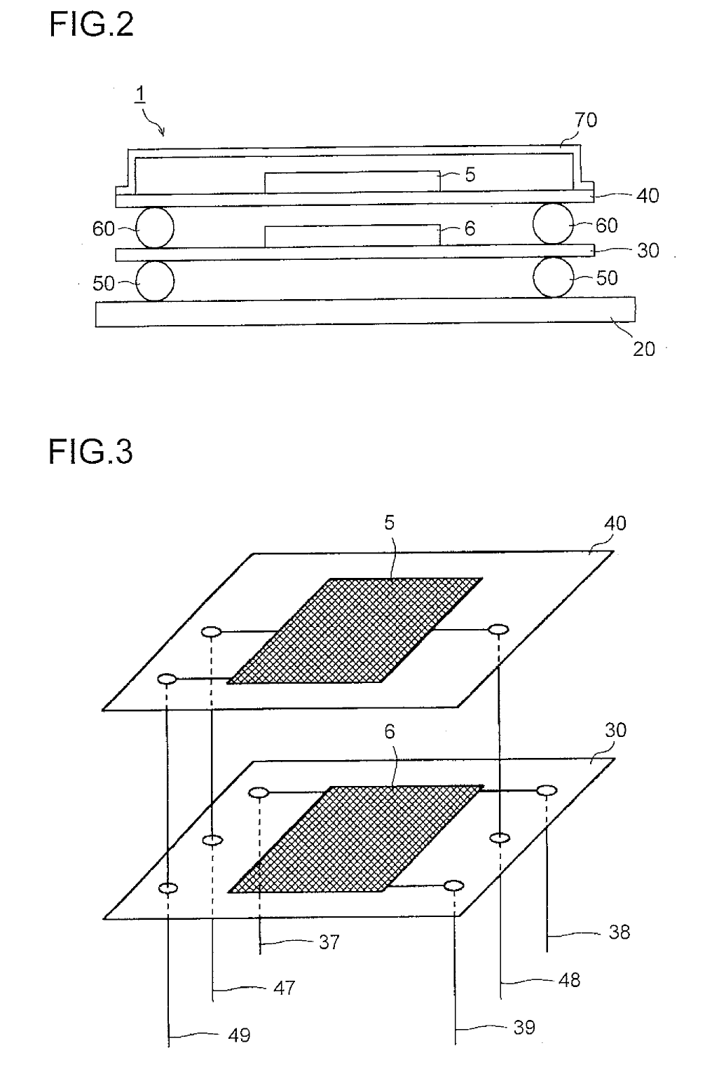

Hereinafter, embodiments of the present invention will be described in detail with reference to the attached drawings. First, a reception apparatus and a television receiver equipped with the reception apparatus according to a first embodiment of the present invention will be described. FIG. 1 is a block diagram to show a general structure of the television receiver equipped with the reception apparatus according to the first embodiment, FIG. 2 is a cross sectional view to show a schematic structure of circuit boards that are an important part of the reception apparatus, and FIG. 3 is a perspective view to show a schematic structure of connection between the circuit boards. Note that the main circuit board is omitted in FIG. 3.

As shown in FIG. 1, a television receiver 1 includes an antenna 2, a reception apparatus 3, and a picture and sound output device 4. The antenna 2 receives a radio frequency signal and delivers it to the reception apparatus 3. The reception apparatus 3 performs a prescribed process on the radio frequency signal from the antenna 2 so as to generate a video signal and an audio signal that arc delivered to the picture and sound output device 4. The picture and sound output device 4 displays pictures on a display device such as a liquid crystal panel based on the video signal from the reception apparatus 3 and produces sounds from a speaker based on the audio signal from the reception apparatus 3.

The reception apparatus 3 is equipped with a tuner circuit portion 5 that converts the radio frequency signal received by the antenna 2 into an intermediate frequency signal, a digital demodulating portion 6 that receives the intermediate frequency signal delivered from the tuner circuit portion 5 and converts it into a compressed digital signal, a digital circuit portion 7 that receives the compressed digital signal delivered from the digital demodulating portion 6 and converts it into a digital video signal and digital audio signal, and a video and audio output circuit 8 that converts the digital video signal and digital audio signal delivered from the digital circuit portion 7 into an analog video signal and analog audio signal. The tuner circuit portion 5, the digital demodulating portion 6, the digital circuit portion 7, and the video and audio output circuit 8 are supplied with an operation voltage from a power supply portion (not shown).

In addition, the reception apparatus 3 is equipped with a quartz oscillator 9 that supplies a clock signal to the tuner circuit portion 5 and the digital demodulating portion 6. In the present embodiment, a frequency of the clock signal that is supplied to the tuner circuit portion 5 is the same as a frequency of the clock signal that is supplied to the digital demodulating portion 6, so both of them shares the quartz oscillator 9. The quartz oscillator 9 is adapted to the specification of the tuner circuit portion 5 in which requirements of frequency deviation and jitter are strict.

The digital demodulating portion 6 includes a digital demodulator IC 10 that is a processor IC performing digital conversion and demodulation of the intermediate frequency signal. In addition, the digital circuit portion 7 includes a picture and sound processor IC 11 that is a processor IC extracting a video signal and an audio signal from the compressed digital signal, a picture and sound process memory 12 for storing process data temporarily when the picture and sound processor IC 11 performs the process, and a program memory 13 for storing codes for controlling the entirety of the reception apparatus 3. The picture and sound processor IC 11 is connected to a line for transmitting analog control signal for control of the tuner circuit portion 5 and the digital demodulator IC 10.

[symbol]

The picture and sound output device 4 includes a display processing portion 14 that performs a process of displaying pictures based on the analog video signal delivered from the video and audio output circuit 8 of the reception apparatus 3, and a sound processing portion 15 that performs a process of producing sounds based on the analog audio signal delivered from the video and audio output circuit 8. The display processing portion 14 and the sound processing portion 15 are supplied with an operation voltage from the power supply portion (not shown).

Here, as to the reception apparatus 3, the tuner circuit portion 5, the digital demodulating portion 6, the digital circuit portion 7, the video and audio output circuit 8, the quartz oscillator 9 and the power supply portion, which are elements of the circuit thereof, are actually mounted on circuit boards, and the circuit boards in the present embodiment are structured as follows.

As shown in FIGS. 1 and 2, the circuit boards in the present embodiment includes a main circuit board 20 that is a mother board, and a first sub circuit board 30 and a second sub circuit board 40 that are child boards independent of each other. As shown in FIG. 2, the first sub circuit board 30 is stacked on the main circuit board 20 via solder balls 50, and the second sub circuit board 40 is stacked on the first sub circuit board 30 via solder balls 60. The main circuit board 20 and the first sub circuit board 30 are connected electrically via the solder balls 50 between them, while the first sub circuit board 30 and the second sub circuit board 40 are connected electrically via the solder balls 60 between them. Note that the first sub circuit board 30 and the second sub circuit board 40 constitute a reception module. In addition, the solder ball in the present embodiment and other embodiments that will be described later is an example of a conductive bonding member.

As shown in FIG. 1, the tuner circuit portion 5 and the quartz oscillator 9 are mounted on the second sub circuit board 40. The digital demodulating portion 6 is mounted on the first sub circuit board 30. The digital circuit portion 7, the video and audio output circuit 8 and the power supply portion (not shown) are mounted on the main circuit board 20. Furthermore, as shown in FIG. 2, a shield plate 70 is attached to the second sub circuit board 40 so as to cover the outer surface, i.e., a surface opposite to the first sub circuit board 30.

Here in particular, as shown in FIG. 3, the digital demodulating portion 6 mounted on the first sub circuit board 30 is supplied with an operation voltage from the power supply portion mounted on the main circuit board 20 via a first power supply line 37, and the tuner circuit portion 5 mounted on the second sub circuit board 40 is supplied with an operation voltage from the power supply portion mounted on the main circuit board 20 via a second power supply line 47. The first power supply line 37 and the second power supply line 47 are not connected to each other and are wired as separate lines. For example, the first power supply line 37 is led to the power supply portion mounted on the main circuit board 20 via solder balls for the first power supply line disposed between the first sub circuit board 30 and the main circuit board 20. The other second power supply line 47 is led to the power supply portion mounted on the main circuit board 20 via solder balls for the second power supply line disposed between the second sub circuit board 40 and the first sub circuit board 30, through holes for the second power supply line formed in the first sub circuit board 30, and solder balls for the second power supply line that are disposed between the first sub circuit board 30 and the main circuit board 20 but are different from the solder balls for the first power supply line. Therefore, the first power supply line 37 does not contact with the tuner circuit portion 5 mounted on the second sub circuit board 40, while the second power supply line 47 does not contact with the digital demodulating portion 6 mounted on the first sub circuit board 30.

Furthermore, the first sub circuit board 30 is provided with a first ground portion that is grounded as a reference of potential there, while the second sub circuit board 40 is provided with a second ground portion that is grounded as a reference of potential there. The first ground portion is connected to a first ground line 38, while the second ground portion is connected to a second ground line 48. The first ground line 38 and the second ground line 48 are wired and grounded as individual lines that are not connected to each other. For example, the first ground line 38 is led to the main circuit board 20 via solder balls for the first ground line disposed between the first sub circuit board 30 and the main circuit board 20. The other second ground line 48 is led to the main circuit board 20 via solder balls for the second ground line disposed between the second sub circuit board 40 and the first sub circuit board 30, through holes for the second ground line formed in the first sub circuit board 30, and solder balls for the second ground line that are disposed between the first sub circuit board 30 and the main circuit board 20 but are different from the solder balls for the first ground line. Therefore, the first ground line 38 does not contact with the tuner circuit portion 5 mounted on the second sub circuit board 40, while the second ground line 48 does not contact with the digital demodulating portion 6 mounted on the first sub circuit board 30.

Furthermore, the first sub circuit board 30 is connected to a signal line 39 for the first sub circuit board from the main circuit board 20, while the second sub circuit board 40 is connected to a signal line 49 for the second sub circuit board from the main circuit board 20. The signal line 39 for the first sub circuit board and the signal line 49 for the second sub circuit board are wired as individual lines that are not connected to each other. For example, the signal line 39 for the first sub circuit board is led to the main circuit board 20 via solder balls for the signal line for the first sub circuit board disposed between the first sub circuit board 30 and the main circuit board 20. The other signal line 49 for the second sub circuit board is led to the main circuit board 20 via solder balls for the signal line for the second sub circuit board disposed between the second sub circuit board 40 and the first sub circuit board 30, through holes for the signal line for the second sub circuit board formed in the first sub circuit board 30, and solder balls for the signal line for the second sub circuit board that are disposed between the first sub circuit board 30 and the main circuit board 20 but are different from the solder balls for the signal line for the first sub circuit board. Therefore, the signal line 39 for the first sub circuit board does not contact with the tuner circuit portion 5 mounted on the second sub circuit board 40, while the signal line 49 for the second sub circuit board does not contact with the digital demodulating portion 6 mounted on the first sub circuit board 30.

Signal lines that need to be connected between the tuner circuit portion 5 mounted on the second sub circuit board 40 and the digital demodulating portion 6 mounted on the first sub circuit board 30, e.g., a control line for AGC, an intermediate frequency signal line, a data line, and the like are connected via solder balls disposed between the second sub circuit board 40 and the first sub circuit board 30. In addition, the quartz oscillator 9 on the second sub circuit board 40 is connected to the tuner circuit portion 5 via a wiring circuit on the second sub circuit board 40, and at the same time it is connected to the digital demodulating portion 6 mounted on the first sub circuit board 30 via solder balls disposed between the second sub circuit board 40 and the first sub circuit board 30.

Since the digital demodulating portion 6 and the tuner circuit portion 5 are disposed separately to the first sub circuit board 30 and the second sub circuit board 40, respectively, in the reception apparatus 3, each area of the first sub circuit board 30 and the second sub circuit board 40 can be reduced. Further, the first sub circuit board 30 is stacked on the main circuit board 20 via the solder balls 50, and the second sub circuit board 40 is stacked on the first sub circuit board 30 via the solder balls 60, so that electric connection is realized among them. Therefore, the entirety of the circuit boards can be controlled to be thin. Thus, the reception apparatus 3 can be downsized. As a result, the television receiver 1 equipped with the reception apparatus 3 can also be downsized naturally.

In addition, a surface of the second sub circuit board 40 that is opposite to the first sub circuit board 30 is covered with the shield plate 70 in the present embodiment. Therefore, the tuner circuit portion 5 mounted on the second sub circuit board 40 can be protected from external noise by the shield plate 70, and unwanted emission can be reduced.

In addition, a frequency of the clock signal that is supplied to the tuner circuit portion 5 is the same as a frequency of the clock signal that is supplied to the digital demodulating portion 6 in the present embodiment. Therefore, both of them can share the single quartz oscillator 9, and it is economical because the number of quartz oscillators can be reduced compared with the case where they have quartz oscillators separately. Furthermore, since the quartz oscillator 9 is adapted to the specification of the tuner circuit portion 5 mounted on the second sub circuit board 40, high reception characteristic can be maintained sufficiently.

In addition, the first ground line 38 connected to the ground portion formed on the first sub circuit board 30 and the second ground line 48 connected to the ground portion formed on the second sub circuit board 40 are wired separately without being connected to each other in the present embodiment. Therefore, if noise occurs in one block, e.g., in the digital demodulating portion 6 on the first sub circuit board 30, the noise hardly propagates to the other block, e.g., the tuner circuit portion 5 on the second sub circuit board 40. As a result, it is able to reduce signal interference between the tuner circuit portion 5 and the digital demodulating portion 6 due to noise that occurs in one side.

Note that the first power supply line 37 that is connected to the first sub circuit board 30 and the second power supply line 47 that is connected to the second sub circuit board 40 are wired separately without being connected to each other, while the signal line 39 for the first sub circuit board that is connected to the first sub circuit board 30 and the signal line 49 for the second sub circuit board that is connected to the second sub circuit board 40 are wired separately without being connected to each other in the present embodiment. Therefore, similarly to the above description, signal interference between the tuner circuit portion 5 and the digital demodulating portion 6 can be reduced.

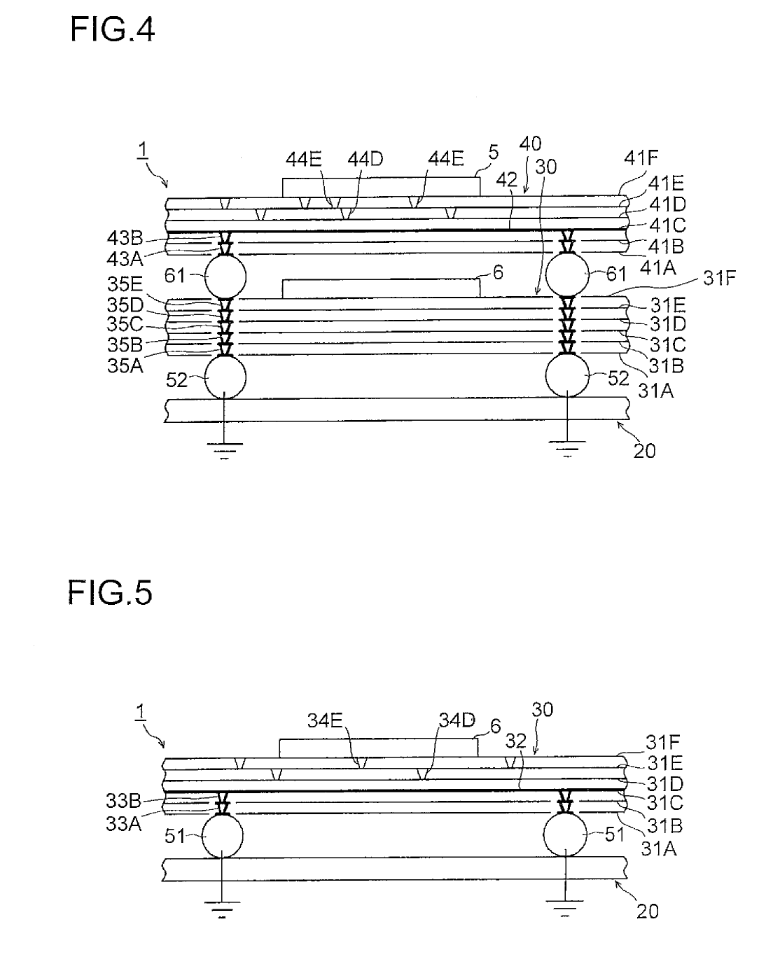

Next, a second embodiment of the present invention will be described with reference to FIGS. 4 and 5. FIGS. 4 and 5 are cross sectional views to show schematic structure of circuit boards that constitute an important part of a reception apparatus of the second embodiment, and FIG. 5 shows another cross section different from FIG. 4. Note that the second sub circuit board is omitted in FIG. 5. A feature of the second embodiment is consideration against digital noise that is radiated from the digital demodulating portion 6 mounted on the first sub circuit board 30 in the first embodiment.

In the present embodiment, as shown in FIGS. 4 and 5, a multilayer board having a plurality of wiring layers is used as the first sub circuit board 30. Here, the first sub circuit board 30 is made up of six wiring layers 31A-31F laminated in this order from the side close to the main circuit board 20. In addition, the second sub circuit board 40 is also made up of a multilayer board having a plurality of wiring layers. Here, the second sub circuit board 40 is made up of six wiring layers 41A-41F laminated in this order from the first sub circuit board 30 side.

Here, as to the first sub circuit board 30, a ground portion of copper foil is formed so as to cover substantially the entire area of the third wiring layer 31C that is a midway wiring layer as shown in FIG. 5, and this works as a first ground layer 32. In other words, the first ground layer 32 is led to the main circuit board 20 and is grounded via solder balls 51 for the first ground line disposed between the first sub circuit board 30 and the main circuit board 20. Here, the connection from the first ground layer 32 to the solder balls 51 for the first ground line is realized by through holes 33A and 33B that extend from the first wiring layer 31A to the third wiring layer 31C in the first sub circuit board 30.

Furthermore, the first sub circuit board 30 includes a wiring circuit of the digital demodulating portion 6 that is formed on the fourth wiring layer 31D, the fifth wiring layer 31E and the sixth wiring layer 31F of the first ground layer 32 that are opposite to the main circuit board 20. Here, the connection of the wiring circuit of the digital demodulating portion 6 is realized by the through hole 34D between the fourth wiring layer 31D and the fifth wiring layer 31E, and it is realized by the through hole 34E between the fifth wiring layer 31E and the sixth wiring layer 31F.

In addition, as to the second sub circuit board 40, a ground portion of copper foil is formed so as to cover substantially the entire area of the third wiring layer 41C that is a midway wiring layer as shown in FIG. 4, and this works as a second ground layer 42. In other words, the second ground layer 42 is led to the main circuit board 20 and is grounded via solder balls 61 for the second ground line disposed between the second sub circuit board 40 and the first sub circuit board 30 and solder balls 52 for the second ground line that are disposed between the first sub circuit board 30 and the main circuit board 20 but are different from the solder balls 51 for the first ground line. Here, the connection from the second ground layer 42 to the solder balls 61 for the second ground line is realized by through holes 43A and 43B that extend from the first wiring layer 41A to the third wiring layer 41C in the second sub circuit board 40. More over, the connection from the solder balls 61 for the second ground line disposed between the second sub circuit board 40 and the first sub circuit board 30 to the solder balls 52 for the second ground line disposed between the first sub circuit board 30 and the main circuit board 20 is realized by through holes 35A-35E that extend from the first wiring layer 31A to the sixth wiring layer 31F in the first sub circuit board 30.

Furthermore, the second sub circuit board 40 includes a wiring circuit of the tuner circuit portion 5 that is formed on the fourth wiring layer 41D, the fifth wiring layer 41E and the sixth wiring layer 41F of the second ground layer 42 that are opposite to the first sub circuit board 30. Here, the connection of the wiring circuit of the tuner circuit portion 5 is realized by the through hole 44D between the fourth wiring layer 41D and the fifth wiring layer 41E, and it is realized by the through hole 44E between the fifth wiring layer 41E and the sixth wiring layer 41F.

In the reception apparatus 3 described above, there is the second ground layer 42 existing widely between the tuner circuit portion 5 mounted on the second sub circuit board 40 and the digital demodulating portion 6 mounted on the first sub circuit board 30. Therefore, the tuner circuit portion 5 is protected by the second ground layer 42 from digital noise that is radiated from the digital demodulating portion 6 so that deterioration of signal quality can be reduced. In other words, the second ground layer 42 works as a shield for the tuner circuit portion 5 here.

In addition, since the first ground layer 32 exists widely between the digital demodulating portion 6 mounted on the first sub circuit board 30 and the digital circuit portion 7, the video and audio output circuit 8 or the like mounted on the main circuit board 20, the digital circuit portion 7, the video and audio output circuit 8 or the like can be protected by the first ground layer 32 from digital noise radiated from the digital demodulating portion 6. Further, the digital demodulating portion 6 is protected from noise radiated from the main circuit board 20, so that deterioration of signal quality can be reduced. In other words, the first ground layer 32 works as a shield for the digital circuit portion 7, the video and audio output circuit 8 and the like, or a shield oppositely for the digital demodulating portion 6 here.

Note that the number of the total wiring layers is not limited, and the layer on which the first ground layer 32 is formed is not limited, as long as the wiring circuit of the digital demodulating portion 6 can be formed on the layer of the first ground layer 32 in the first sub circuit board 30 that is opposite to the main circuit board 20. In the same manner, the number of the total wiring layers is not limited, and the layer on which the second ground layer 42 is formed is not limited, as long as the wiring circuit of the tuner circuit portion 5 can be formed on the layer of the second ground layer 42 in the second sub circuit board 40 that is opposite to the first sub circuit board 30.

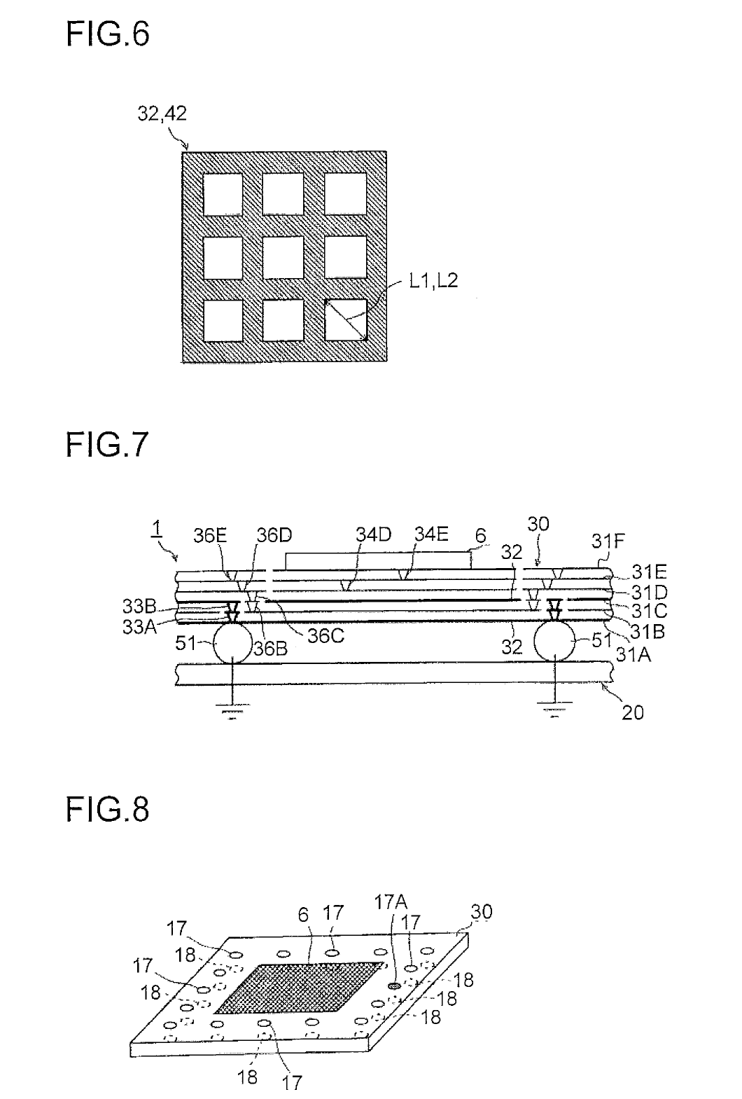

Next, a third embodiment of the present invention will be described with reference to FIG. 6. FIG. 6 is a plan view to show schematically the first and the second ground layers in circuit boards that constitute an important part of a reception apparatus of the third embodiment. A feature of the third embodiment is that accuracy of dimension of the first sub circuit board 30 and the second sub circuit board 40 in the second embodiment is secured. In the second embodiment described above, the ground portion of the first ground layer 32 in the first sub circuit board 30 covers almost the entire surface. Therefore, the first sub circuit board 30 has a tendency to be warped when it is manufactured. For the same reason, the second sub circuit board 40 also has a tendency to be warped when it is manufactured.

In the present embodiment, as shown in FIG. 6, the first ground layer 32 in the first sub circuit board 30 has a grid-like pattern of the copper ground portion. Furthermore, a maximum opening size L1 of the ground portion pattern is set to a value smaller than a wavelength of noise to be blocked, i.e., smaller than one half of a wavelength of an electric signal that is handled here.

In the same manner, the second ground layer 42 in the second sub circuit board 40 has a grid-like pattern of the copper ground portion. Furthermore, a maximum opening size L2 of the ground portion pattern is set to a value smaller than a wavelength of noise to be blocked, i.e., smaller than one half of a wavelength of an electric signal that is handled here.

Thus, residual strain in the first ground layer 32 due to the ground portion pattern is relieved, so that a warp of the first sub circuit board 30 when it is manufactured can be suppressed and that accuracy of dimension is improved. Moreover, the entire weight of the first sub circuit board 30 can be reduced. In addition, the shield function of the first ground layer 32 can be maintained by restricting the maximum opening size L1 of the ground portion pattern.

In the same manner, residual strain in the second ground layer 42 due to the ground portion pattern is relieved, so that a warp of the second sub circuit board 40 when it is manufactured can be suppressed and that accuracy of dimension is improved. Moreover, the entire weight of the second sub circuit board 40 can be reduced. In addition, the shield function of the second ground layer 42 can be maintained by restricting the maximum opening size L2 of the ground portion pattern.

Next, a fourth embodiment of the present invention will be described with reference to FIG. 7. FIG. 7 is a cross sectional view to show schematically a structure of circuit boards that is an important part of a reception apparatus in the fourth embodiment of the present invention. Note that the second sub circuit board is not shown in FIG. 7. A feature of the fourth embodiment is that the first sub circuit board 30 in the second or the third embodiment is modified.

In the present embodiment, as shown in FIG. 7, a multilayer board that is made up of six wiring layers 31A-31F laminated in this order from the main circuit board 20 side is used as the first sub circuit board 30. Here, as to the first sub circuit board 30, a ground portion of copper foil is formed so as to cover substantially the entire area of each of the first wiring layer 31A and the third wiring layer 31C that is a midway wiring layer, and each of them works as the first ground layer 32. In other words, these first ground layers 32 are led to the main circuit board 20 and grounded via the solder balls 51 for the first ground line disposed between the first sub circuit board 30 and the main circuit board 20. Here, the connection from the first ground layer 32 to the solder balls 51 for the first ground line in the third wiring layer 31C is realized by the through holes 33A and 33B that extend from the first wiring layer 31A to the third wiring layer 31C thereof in the first sub circuit board 30.

Furthermore, the first sub circuit board 30 includes the wiring circuit of the digital demodulating portion 6 that is formed on the fourth wiring layer 31D, the fifth wiring layer 31E and the sixth wiring layer 31F of the first ground layer 32 in the third wiring layer 31C that are opposite to the main circuit board 20. Here, the connection of the wiring circuit of the digital demodulating portion 6 is realized by the through hole 34D between the fourth wiring layer 31D and the fifth wiring layer 31E, and it is realized by the through hole 34E between the fifth wiring layer 31E and the sixth wiring layer 31F.

In addition, as to the first sub circuit board 30, an analog signal line that should not be affected by signals around is disposed on the second wiring layer 31B disposed between the first ground layer 32 on the first wiring layer 31A and the first ground layer 32 on the third wiring layer 31C. This analog signal line is connected to the second sub circuit board 40 finally via through holes 36B-36E that extend from the second wiring layer 31B to the sixth wiring layer 31F, and it is connected to the main circuit board 20 finally via through holes (not shown) that extend from the first wiring layer 31A to the second wiring layer 31B. However, the analog signal line is not connected to each of the first ground layers 32 and the wiring circuit of the digital demodulating portion 6.

Although the analog signal line on the first sub circuit board 30 is sensitive and easily affected by digital noise from the digital demodulating portion 6 originally, it can be protected from the digital noise because it is disposed between the first ground layers 32 according to the structure described above. In other words, the first ground layers 32 in this embodiment further work as a shield for the analog signal line, too.

Note that the number of the total wiring layers is not limited, and the layer on which the first ground layer 32 is formed is not limited, and further the number of the wiring layers disposed between the first ground layers 32 is not limited, as long as the wiring circuit of the digital demodulating portion 6 can be formed on the layer of the first ground layers 32 in the first sub circuit board 30 that is opposite to the main circuit board 20 and as long as the wiring layer can be exist between the first ground layers 32. In order to satisfy this condition, at least four wiring layers are required.

Next, a fifth embodiment of the present invention will be described with reference to FIG. 8. FIG. 8 is a perspective view to show schematically a structure of a circuit board that constitutes an important part of a reception apparatus of the fifth embodiment. Note that the main circuit board and the second sub circuit board are not shown in FIG. 8. A feature of the fifth embodiment is that the connection positions with the solder balls on the first sub circuit board 30 in the first to the fourth embodiments are specified.

In the present embodiment, as shown in FIG. 8, as to the first sub circuit board 30, a plurality of connection terminals 17 that are connected to the second sub circuit board 40 via the solder balls are disposed with predetermined spaces along the outer edge thereof on the upper surface, i.e., the surface that is opposed to the second sub circuit board 40. The lower surface thereof, i.e., the surface that is opposed to the main circuit board 20 is provided with connection terminals 18 that are connected to the main circuit board 20 via the solder ball at the positions corresponding to the positions of the connection terminal 17 on the upper surface.

Here, if a connection terminal 17A of the line for transmitting an analog control signal such as a signal for controlling a gain of a variable gain amplifier of the tuner circuit portion 5 is assigned to one of the connection terminals 17 on the upper surface, the connection terminal 18 on the lower surface at the position just under the terminal 17A for the analog control signal is not assigned to a connection terminal of a line for transmitting a digital signal frequently. In other words, the terminal for the digital signal is assigned to the connection terminal 18 on the lower surface at the position shifted from the position just under the terminal 17A for the analog control signal.

Thus, a distance between the terminal 17A for the analog control signal and the terminal for the digital signal is secured. As a result, influence of noise from the terminal for the digital signal to the terminal 17A for the analog control signal can be reduced, so that deterioration of quality of a received signal can be suppressed. If the terminal for the digital signal is assigned to the position just under the terminal 17A for the analog control signal, the distance between them becomes small. As a result, noise from the terminal for the digital signal may affect the signal at the terminal 17A for the analog control signal, so the signal may be AM-modulated resulting in deterioration of signal quality.

In addition, it is preferable from the same viewpoint not to assign a connection terminal of a line for transmitting a digital signal frequently to a connection terminal 17 that neighbors the terminal 17A for the analog control signal on the upper surface of the first sub circuit board 30.

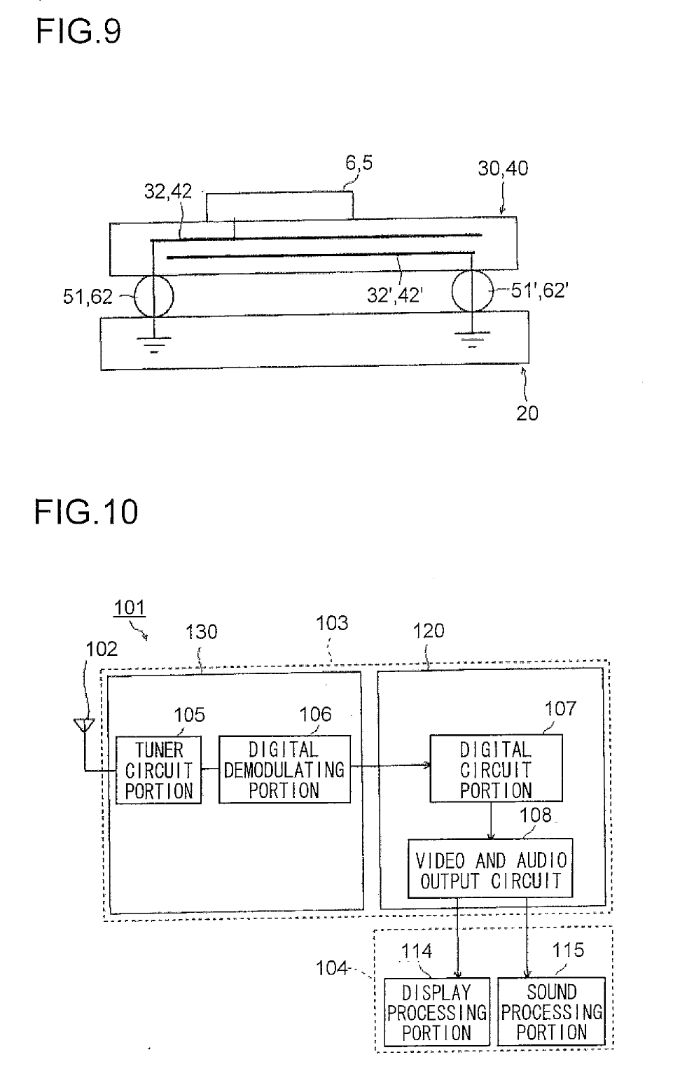

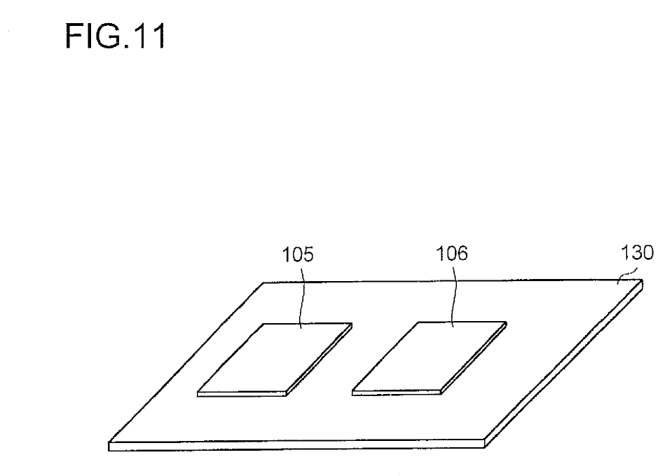

The present invention is not limited to the embodiments described above but can be modified variously within the scope of the present invention without deviating from the spirit of the invention. For example, FIG. 9 is a cross sectional view to show schematically a variation of the structure of the circuit boards. As shown in FIG. 9, it is possible to provide a ground layer 32′ that is separated as a circuit from the digital demodulating portion 6 to be a circuit portion there in the first sub circuit board 30, aside from the ground layer 32 to which the ground of the digital demodulating portion 6 is connected. As a pattern of the ground layer 32′, a solid pattern or a mesh pattern that covers substantially the entire surface can be used. Furthermore, in the second sub circuit board 40 too, it is possible to provide a ground layer 42′ that is separated as a circuit from the tuner circuit portion 5 to be a circuit portion there, aside from the ground layer 42 to which the ground of the tuner circuit portion 5 is connected. As a pattern of the ground layer 42′ too, a solid pattern or a mesh pattern that covers substantially the entire surface can be used. This structure in which the double ground layers are provided can be applied at least one of the first sub circuit board 30 and the second sub circuit board 40.

The present invention is useful for a reception apparatus that receives a radio frequency signal such as digital television broadcasting and demodulates the same and a television receiver equipped with the reception apparatus.

What is claimed is:

1. A reception module, comprising:
a tuner circuit portion; and
a digital demodulating portion that converts a signal from the tuner circuit portion into a digital signal, wherein
a first sub circuit hoard on which the digital demodulating portion is mounted and a second sub circuit board on which the tuner circuit portion is mounted are stacked via conductive bonding members, so that the first sub circuit board and the second sub circuit board are connected to each other via the conductive bonding members.

2. A reception apparatus, comprising:
a tuner circuit portion;
a digital demodulating portion that converts a signal from the tuner circuit portion into a digital signal; and
a digital circuit portion that converts a digital signal from the digital demodulating portion into a digital video signal and digital audio signal, wherein
a first sub circuit board on which the digital demodulating portion is mounted and a second sub circuit board on which the tuner circuit portion is mounted are stacked on a main circuit board on which the digital circuit portion is mounted, in this order, via conductive bonding members, so that the main circuit board, the first sub circuit board, and the second sub circuit board are connected to each other via the conductive bonding members.

3. The reception apparatus according to claim 2, wherein the second sub circuit board is covered with a shield plate on a surface opposite to the first sub circuit board.

4. The reception apparatus according to claim 2, wherein a first ground line that is connected to a ground portion on the first sub circuit board and a second ground line that is connected to a ground portion of the second sub circuit board are wired separately and are grounded.

5. The reception apparatus according to claim 4, wherein
the first ground line is led to the main circuit board via a conductive bonding member for the first ground line disposed between the first sub circuit board and the main circuit board, and
the second ground line is led to the main circuit board via a conductive bonding member for the second ground line disposed between the second sub circuit board and the first sub circuit board, a through hole for the second ground line formed in the first sub circuit board, and a conductive bonding member for the second ground line that is disposed between the first sub circuit board and the main circuit board and is different from the conductive bonding member for the first ground line.

6. The reception apparatus according to claim 4, wherein the first sub circuit board is a multilayer board having a plurality of wiring layers that includes a first ground layer on which the ground portion is formed, and a wiring circuit of the digital demodulating portion is formed on a layer of the first ground layer opposite to the main circuit board.

7. The reception apparatus according to claim 4, wherein
the first sub circuit board is a multilayer board having at least four wiring layers that includes two first ground layers each of which is provided with the ground portion separately,
a wiring circuit of the digital demodulating portion is formed on a layer of the first ground layer opposite to the main circuit board, and
an analog signal line is disposed at a wiring layer between the two first ground layers.

8. The reception apparatus according to claim 6, wherein a pattern of the ground portion on the first ground layer is a mesh pattern, and a maximum opening size of the mesh is smaller than one half of a wavelength of an electric signal that is handled.

9. The reception apparatus according to claim 4, wherein the second sub circuit board is a multilayer board having a plurality of wiring layers that includes a second ground layer on which the ground portion is formed, and a wiring circuit of the tuner circuit portion is formed on a layer of the second ground layer opposite to the first sub circuit board.

10. The reception apparatus according to claim 9, wherein a pattern of the ground portion on the second ground layer is a mesh pattern, and a maximum opening size of the mesh is smaller than one half of a wavelength of an electric signal that is handled.

11. The reception apparatus according to claim 2, wherein a connection position through which an analog control signal is transmitted among connection positions between the first sub circuit board and the second sub circuit board via the conductive bonding members is shifted from a connection position through which a digital signal is transmitted among connection positions between the main circuit board and the first sub circuit board via the conductive bonding members.

12. The reception apparatus according to claim 2, wherein a quartz oscillator for supplying a clock signal to the tuner circuit portion is mounted on the second sub circuit board, and the quartz oscillator supplies the clock signal also to the digital demodulating portion on the first sub circuit board via conductive bonding members disposed between the second sub circuit board and the first sub circuit board.

13. A television receiver comprising:
a reception apparatus according to claim 2 which is provided with a video and audio output circuit that converts the digital video signal and digital audio signal from the digital circuit portion into an analog video signal and analog audio signal; and
a picture and sound output device that displays pictures based on a video signal delivered from the reception apparatus and produces sounds based on an audio signal delivered from the reception apparatus.
